(19) United States
(12) Patent Application Publication
(10) Pub. No.: US 2012/0052737 A1
(43) Pub. Date: Mar. 1, 2012

(54) WALL PLATE ASSEMBLY

(75) Inventors: CHEN-XI WANG, Kunshan (CN); HONG-QIANG HAN, Kunshan (CN); ZI-QIANG ZHU, Kunshan (CN)

(73) Assignee: HON HAI PRECISION INDUSTRY CO., LTD., New Taipei (TW)

(21) Appl. No.: 13/221,809

(22) Filed: Aug. 30, 2011

(30) Foreign Application Priority Data
Sep. 1, 2010 (CN) 201020513068.7

(51) Int. Cl. H01R 31/06

(52) U.S. Cl. 439/628

(57) ABSTRACT

A wall plate assembly (100) includes a wall plate (20) having an opening (201) passing therethrough, and an adapter (10) fixedly provided at a back side of said wall plate. The adapter (10) includes a printed circuit board (101), a first and second connectors (102, 103) both mounted onto the printed circuit board, and a case (105). The first connector includes an insulative housing (1), a metal shell (3) retained on the insulative housing and having a receiving space (106), and a set of contacts (2) having contacting portions (21) extending into the receiving space and tail portions (23) being mounted onto the printed circuit board. The case (105) has a first sleeve portion (43) surrounding the metal shell (3) with the receiving space (106) opened forwardly and corresponding to the opening (102). The first sleeve portion (43) and the metal shell (3) protrude forwardly into the opening (201) together.

### BACKGROUND OF THE INVENTION

1. Field of the Invention

The present invention relates to a wall plate assembly, and more particularly to a wall plate assembly having an adapter attached to a wall plate.

2. Description of Related Art

At present, many types of high speed transmission connectors such as HDMI (High Definition Multimedia Interface), DisplayPort, or DiiVA (Digital Interactive Interface for Video & Audio) connectors are widely used as input/output interfaces adapted for many electronic devices, such as personal computer and related peripherals so as to transmit high quality audio and video signals. Disposition of these electronic devices in house requires extra spaces and extending the length of cables to provide a remote connection of these electronic devices. However, it is neither beautiful nor safe to directly arrange the cables on outsides of the walls, the floor or the ceiling of the house.

Hence, a wall plate assembly is desired to overcome the above problems.

### BRIEF SUMMARY OF THE INVENTION

According to one aspect of the present invention, a wall plate assembly comprises: a wall plate defining an opening passing therethrough in a front-to-back direction, and an adapter fixedly provided at a back side of said wall plate. The adapter comprises a printed circuit board, a first and second connectors both mounted onto the printed circuit board, and a case surrounding the printed circuit board, and the first and second connectors. The first connector comprises an insulative housing, a metal shell retained on the insulative housing and defining a receiving space for receiving a first plug, and a plurality of contacts disposed on the insulative housing and having contacting portions extending into the receiving space for mating with the first plug, and tail portions opposite to the contacting portions and being mounted onto the printed circuit board. The case has a first sleeve portion surrounding the metal shell of the first connector under a condition the receiving space is opened forwardly and corresponding to the opening for insertion of a first plug. The first sleeve portion and the metal shell protrude forwardly into the opening together.

According to another aspect of the present invention, a wall plate assembly for being installed on a wall of a house comprises: a wall plate defining an opening passing therethrough in a front-to-back direction, and an adapter fixedly provided at a back side of said wall plate. The adapter comprises a printed circuit board, a first connector corresponding to the opening, a second connector hidden into the wall of the house, a metal shielding member attached to the first and second connectors, and a case surrounding the printed circuit board, the first and second connectors, and the shielding member. The first and second connectors are mounted onto the printed circuit board in a back to back manner. Each of the first and second connectors comprises an insulative housing, a metal shell retained on the insulative housing and defining a receiving space, and a plurality of contacts disposed on the insulative housing and having contacting portions extending into the receiving space, and tail portions extending outwardly of the insulative housing and being mounted onto the printed circuit board. The shielding member shields the tail portions of the first and second connectors and contacts with the metal shells of the first and second connectors simultaneously.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a wall plate assembly according to an embodiment of the present invention;

FIG. 2 is a perspective view of the wall plate assembly with a wall plate removed therefrom;

FIG. 3 is a partially exploded view of the wall plate assembly without the wall plate shown in FIG. 2;

FIG. 4 is a further partially explode view of the wall plate assembly without the wall plate shown in FIG. 3; and

FIG. 5 is an exploded view of the wall plate assembly shown in FIG. 2 further with a case removed therefrom.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details.

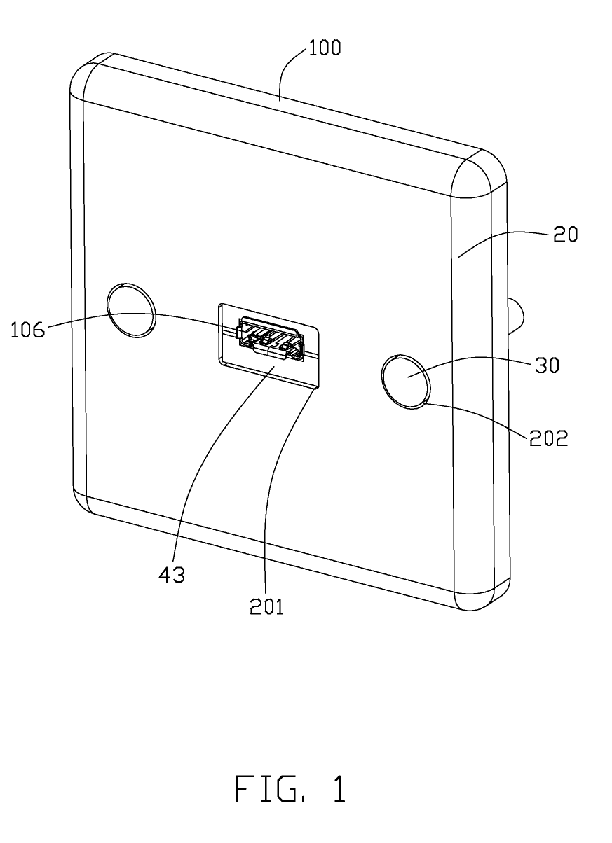

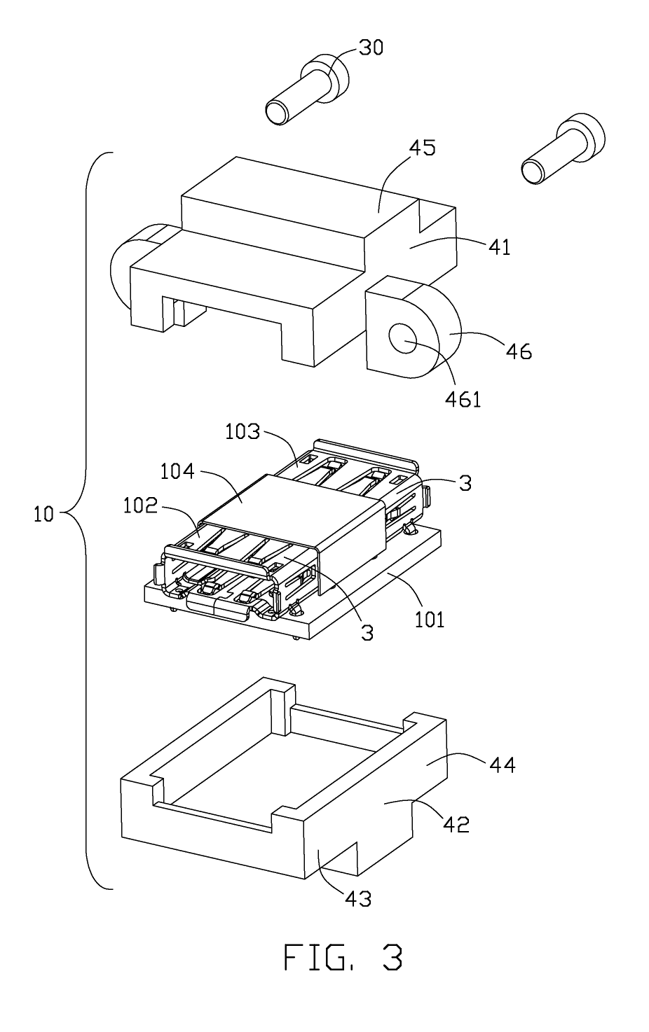

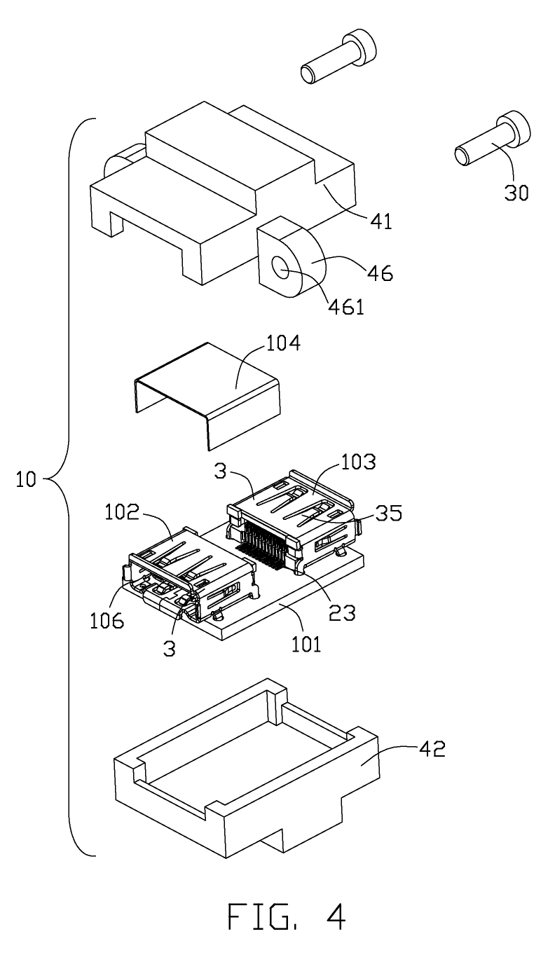

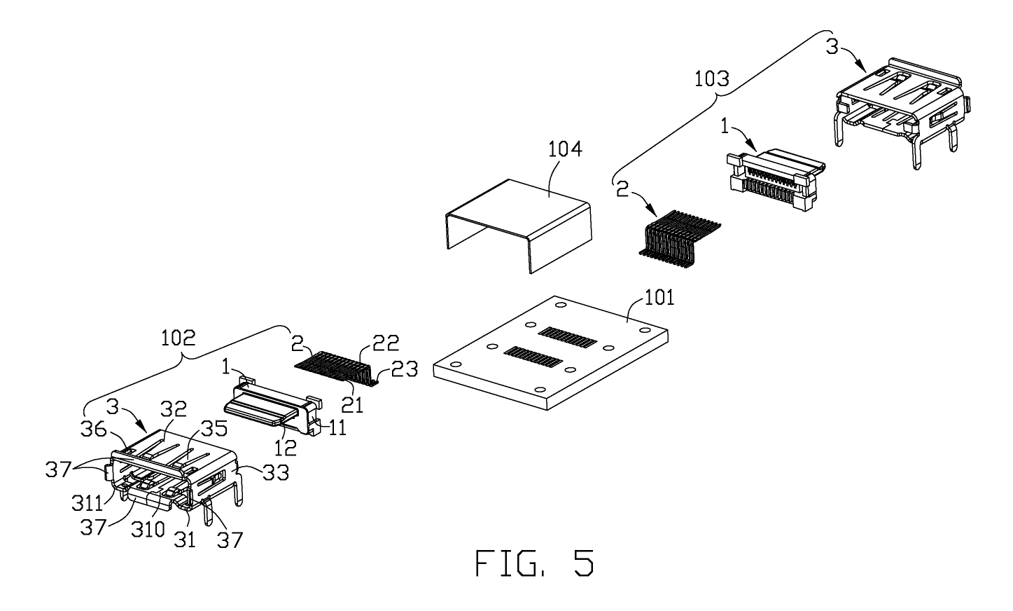

Referring to FIGS. 1-5, a wall plate assembly 100 according to an embodiment of the present invention is provided for being installed on a wall, a ceiling or a floor of a house. The wall plate assembly 100 comprises a wall plate 20 having an opening 201 passing therethrough in a front-to-back direction, an adapter 10 assembled to the wall plate 20 and corresponding with the opening 201, and two pairs of screws 30. The wall plate 20 has a pair of screw holes 202 formed thereon for one pair of screws 30 assembled thereto so as to orientate the wall plate 20 onto the wall, ceiling or floor of the house.

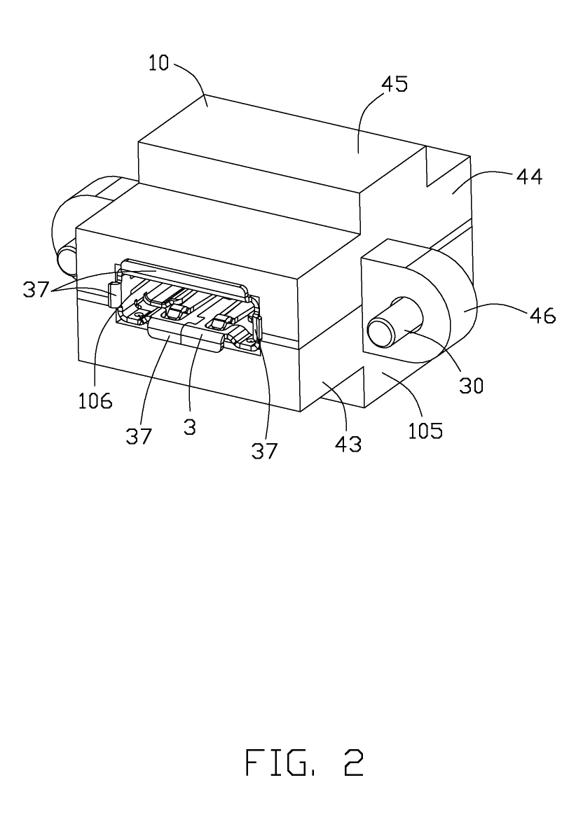

Referring to FIGS. 2-5, the adapter 10 includes a PCB (printed circuit board) 101, a first and second connectors 102, 103 mounted onto the PCB 10 simultaneously in a back to back manner, a shielding member 104 attached to the first and second connectors 102, 103, and a case 105 surrounding the PCB 101, the first and second connectors 102, 103, and the shielding member 104. In this embodiment, both of the first and second connectors are DiiVA (Digital Interactive Interface for Video & Audio) receptacle connectors. it is also to be understood, in other embodiments, both of the first and second connectors could be HDMI (High Definition Multimedia Interface) receptacle connectors, DisplayPort receptacle connectors, or other connectors; and the first connector 102 could be different from the second connector 103, for instance, the first connector 102 is a DiiVA receptacle connector, and the second connector 103 is a RJ type modular jack.

Because the first connector 102 is same as the second connector 103, only the first connector 102 is described hereafter, structures of the second connector 103 are same as the first connector, and detailed descriptions about the second connector 103 are omitted here. The first connector 102 includes an insulative housing 1, a plurality of contacts 2 disposed on the insulative housing 1 and a metal shell 3 assembled to the insulative housing 1.

The insulative housing 1 has a body portion 11 and a tongue portion 12 extending forwardly from a front end of the body portion 11. The contacts 2 have contacting portions 21 arranged in one row and retained in the a lower surface of the tongue portion 12, tail portions 23 extending backwardly beyond the insulative housing 1, and connecting portions 22 retained in the insulative housing 1 and connecting the contacting portions 21 and the tail portions 23. The tail portions 23 are arranged in one row and parallel to the contacting portions 21. In this embodiment, the contacts 2 are assembled to the insulative housing 1, it is also to be understood, in other embodiments, the contacts 2 could be insert molded into the insulative housing 1. The metal shell 3 is stamped and formed of conductive sheet metal materials. The metal shell 3 is retained around the body portion 11. The metal shell 3 has a planar top wall 32, a bottom wall 31 opposite to the top wall 32, a pair of side walls 33 connecting the top wall 32 and the bottom wall 31, and a receiving space 106 surrounded by the top wall 32, the bottom wall 31 and the side walls 33 and corresponding with the opening 201 for receiving a first plug (not shown). The tongue portion 12 and the contacting portions 21 are accommodated in the receiving space 106. The bottom wall 31 has a depressed wall 310 depressed upwardly toward the receiving space 106 so as to prevent the first plug from mismating the first connector 102, and a pair of connecting walls 311 connecting the side walls 33 and the depressed wall 310. The connecting walls 311 have a same width in the transverse direction and are parallel to the top wall 32. Each of the top wall 32 and the depressed wall 310 has a pair of spring tabs 35 extending forwardly and protruding inwardly into the receiving space 34. The top wall 32 has a pair of perforations 36 at two lateral sides of the spring tabs 35 for being latched by the first plug. Each of the top wall 32, the depressed wall 310, and the side walls 33 has a flange 37 protruding outwardly from a front edge thereof and being isolate from each other.

The tail portions 23 of the contacts 2 of the first and second connectors 102, 103 are exposed on outsides of the insulative housing 1 and the metal shell 3. The shielding member 104 shields the tail portions 23 of the first and second connectors 102, 103 so as to prevent the contacts 2 of the first and second connectors 102, 103 from electromagnetic interference. The shielding member 104 contacts with the metal shells 3 of the first and second connectors 102, 103 so as to electrically connect the metal shell 3 of the first and second connectors 102, 103. Therefore, the static electricity created on the first or second connectors 102, 103 could be discharged away reliably.

The case 105 has a first part 41 and a second part 42 assembled together to encompass the PCB 101, the first and second connectors 102, 103, and the shielding member 104. The case 105 has a first sleeve portion 43 surrounding the first connector 102 with the flanges 37 on the metal shell 3 of the first connector 102 exposed to exterior, a second sleeve portion 44 surrounding the second connector 103 with the flanges 37 on the metal shell 37 of the second connector 103 exposed to exterior, and an expanding portion 45 protruding upwardly and downwardly from a middle portion located between the first and second sleeve portions 43, 44 and resisting a back face of the wall plate 20. The first sleeve portion 43 and the metal shell 3 of the first connector 102 together protrude into the opening 201 of the wall plate 20. The flanges 37 of the first and second connectors 102, 103 are resisted forwardly or backwardly by faces of the first and second sleeve portions 43, 44, therefore, when the first plug is inserted into the first connector 102, the metal shell 3 of the first connector 102 can not be pushed backwardly away from the opening 201, and the first plug will mate with the first connector 102 reliably. the first and second sleeve portions 43, 44 surrounding the metal shells 3 of the first and second connectors 102, 103 could prevent the metal shells 3 from breakage or deformation. The case 105 has a pair of ear portions 46 protruding outwardly from two sides thereof and having through holes 461 passing therethrough along the front-to-back direction. The other pair of screws 30 are assembled through the through holes 461 and orientate the adapter 10 onto the wall plate 20.

When the wall plate assembly 100 is installed onto the wall, the ceiling or the floor of the house, the first connector 102 received in the opening 201 can mate with the first plug to connect to an electrical device, the second connector 103 is hidden into the wall, the ceiling or the floor of the house and mate with a second plug which connects to a cable extending into the wall, the ceiling or the floor of the house. The first and second connectors 102, 103 are converted into each other via the PCB 101, the first connector 102 does not directly connect to a cable which extends into the wall, the ceiling or the floor of the house and will be replaced expediently with another one when it does not work. According to another embodiment, the second connector 103 is a RJ type modular jack, a RJ type plug with a cable extends into the wall, the ceiling or the floor of the house to connect the RJ modular jacks of two wall plates assemblies 100 that are arranged at two locations far apart, because the RJ type cable has the characteristics of high flexibility and small diameter, the wiring arrangement of the RJ type cable is easy, further, because the cost of the RJ type cable is much low, the use of the RJ type cable for connection between the RJ modular jacks of the two wall plates assemblies 100 saves much the installation cost.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A wall plate assembly comprising:
a wall plate defining an opening passing therethrough in a front-to-back direction; and
an adapter fixedly provided at a back side of said wall plate and comprising a printed circuit board, a first and second connectors both mounted onto the printed circuit board, and a case surrounding the printed circuit board, and the first and second connectors, the first connector comprising an insulative housing, a metal shell retained on the insulative housing and defining a receiving space for receiving a first plug, and a plurality of contacts disposed on the insulative housing and having contacting portions extending into the receiving space for mating with the first plug, and tail portions opposite to the contacting portions and being mounted onto the printed circuit board, the case having a first sleeve portion surrounding the metal shell of the first connector under a condition that the receiving space is opened forwardly and corresponding to the opening for insertion of a first plug, the first sleeve portion and the metal shell protruding forwardly into the opening together.

2. The wall plate assembly according to claim 1, wherein the metal shell has a plurality of flanges protruding outwardly around the receiving space at a front end thereof and being resisted forwardly by a front face of the sleeve portion.

3. The wall plate assembly according to claim 1, wherein the case has an expanding portion protruding upwardly and downwardly at a rear side of the first sleeve portion and resisting the wall plate forwardly.

4. The wall plate assembly according to claim 1, wherein the case has a pair of ear portions protruding outwardly from two sides thereof and having through holes passing therethrough in the front-to-back direction, the wall plate assembly has a pair of screws assembled through the through holes and orientating the case onto the wall plate.

5. The wall plate assembly according to claim 1, wherein the tail portions of the contacts of the first connector are parallel to the corresponding contacting portions, the second connector comprises an insulative housing, a metal shell retained on the insulative housing and defining a receiving space; and a plurality of contacts disposed on the insulative housing and having contacting portions extending into the receiving space, and tail portions opposite to the contacting portions and being mounted onto the printed circuit board, the tail portions of the contacts of the second connector are parallel to the corresponding contacting portions, the first connector is opposed to the second connector under condition that the tail portions of the first and second connectors are mounted onto an area of the printed circuit board between the insulative housings of the first and second connectors in the front-to-back direction.

6. The wall plate assembly according to claim 5, wherein the wall plate assembly comprises a shielding member shielding the tail portions of the first and second connectors and surrounded by the case.

7. The wall plate assembly according to claim 6, wherein the shielding member contacts with the metal shells of the first and second connectors simultaneously.

8. A wall plate assembly for being installed on a wall of a house comprising:
a wall plate defining an opening passing therethrough in a front-to-back direction; and
an adapter fixedly provided at a back side of said wall plate and comprising a printed circuit board, a first connector corresponding to the opening, a second connector hidden into the wall of the house, a metal shielding member attached to the first and second connectors, and a case surrounding the printed circuit board, the first and second connectors, and the shielding member, the first and second connectors being mounted onto the printed circuit board in a back to back manner, each of the first and second connectors comprising an insulative housing, a metal shell retained on the insulative housing and defining a receiving space, and a plurality of contacts disposed on the insulative housing and having contacting portions extending into the receiving space, and tail portions extending outwardly of the insulative housing and being mounted onto the printed circuit board;
wherein the shielding member shields the tail portions of the first and second connectors and contacts with the metal shells of the first and second connectors simultaneously.

9. The wall plate assembly according to claim 8, wherein the tail portions of the contacts of the first and second connectors are parallel to the corresponding contacting portions and located between the insulative housings of the first and second connectors in the front-to-back direction.

10. The wall plate assembly according to claim 8, wherein the case has a first sleeve portion surrounding the metal shell of the first connector with the receiving space of the first connector opened forwardly and corresponding to the opening for insertion of a first plug, and a second sleeve portion surrounding the metal shell of the second connector opened backwardly for insertion of a second plug.

11. The wall plate assembly according to claim 10, wherein the first sleeve portion and the metal shell protruding forwardly into the opening together.

12. The wall plate assembly according to claim 11, wherein the metal shell of the first connector has a top wall, a bottom wall opposite to the top wall, and a pair of side walls connecting the top and bottom walls, the receiving space of the first connector is surrounded by the top wall, the bottom wall, and the side walls, the bottom wall has a depressed wall depressed toward the receiving space, each of the top wall, the depressed wall and the side walls has a flange protruding outwardly therefrom and being resisted forwardly by a front face of the sleeve portion.

13. The wall plate assembly according to claim 10, wherein the case has an expanding portion protruding upwardly and downwardly from a middle portion located between the first and second sleeve portions and resisting the wall plate forwardly.

14. The wall plate assembly according to claim 13, wherein the case has a pair of ear portions protruding outwardly from two sides of the middle portion and having through holes passing therethrough in the front-to-back direction, the wall plate assembly has a pair of screws assembled through the through holes and orientating the case onto the wall plate.

15. A wall plate assembly comprising:
a wall plate defining a rectangular opening which is exposed to an exterior and defines a long side in a lengthwise direction and a short side in a transverse direction perpendicular to said lengthwise direction;
an adaptor including a case which is assembled to a back side of the wall plate and includes a first part and a second assembled to each other in the transverse direction so as to form a receiving cavity and opposite through openings by two sides of the receiving cavity in a front-to-back direction perpendicular to said lengthwise direction and said transverse direction under condition that one of the through opening is intimately located behind the rectangular opening of the wall plate;
a printed circuit board disposed in the receiving cavity in a plane defined by said front-to-back direction and said lengthwise direction; and
a pair of receptacle connectors mounted upon two opposite ends of the printed circuit board in said front-to-back direction and facing away from each other; wherein
one of said receptacle connectors includes a metallic shell defining a mating opening snugly received in the corresponding through opening and accessible from the exterior via the rectangular opening.

16. The wall plate assembly as claimed in claim 15, wherein both said receptacle connectors are essentially identical to each other.

17. The wall plate assembly as claimed in claim 16, wherein a metallic shell mounted to a middle area of the printed circuit board to shield rear sections of both said pair receptacle connectors.

18. The wall plate assembly as claimed in claim 15, wherein the case defines an expansion portion to abut against the back side of the wall plate.

19. The wall plate assembly as clamed in claim 18, wherein said case further includes a pair of ears on two side in the lengthwise direction for fastening the case to the wall plate.
